(19) United States
(12) Patent Application Publication
(10) Pub. No.: US 2008/0121483 A1
(43) Pub. Date: May 29, 2008

(54) Hydrodynamic torque converter

(75) Inventors: Christoph Sasse, Schweinfurt (DE); Bernd Reinhardt, Schonungen (DE)

Correspondence Address: COHEN, PONTANI, LIEBERMAN & PAVANE, 551 FIFTH AVENUE, SUITE 1210, NEW YORK, NY, 10176, US

(73) Assignee: ZF Friedrichshafen AG, Friedrichshafen (DE)

(21) Appl. No.: 11/986,182

(22) Filed: Nov. 20, 2007

(30) Foreign Application Priority Data
Nov. 23, 2006 (DE) 10 2006 055 271.7

(51) Int. Cl. F16H 45/00

(52) U.S. Cl. 192/3.3

(57) ABSTRACT

A hydrodynamic torque converter includes a housing with an interior space and a pump wheel; a turbine wheel installed in the interior space and rotatable about an axis with respect to the housing; and a bridging clutch including a first friction surface formation connected essentially nonrotatably to the converter housing, and a second friction surface formation connected essentially nonrotatably to the turbine wheel. A piston element divides the interior space into a first space containing the turbine wheel and a second space facing away from the first space, wherein a pressure increase in the second space brings the first and second friction formations into frictional engagement to connect the housing to the turbine wheel for rotation in common. Fluid flow openings in the piston element connect the second space to the first space in the radial area of the friction surface formations.

### BACKGROUND OF THE INVENTION

1. Field of the Invention

The present invention pertains to a hydrodynamic torque converter including a converter housing with a pump wheel; a turbine wheel installed in an interior space of the converter housing; and a bridging clutch arrangement with a first friction surface formation, which is connected essentially nonrotatably to the housing, and a second friction surface formation, which is connected essentially nonrotatably to the turbine wheel. The interior space of the housing is divided by a piston element into a first space containing the turbine wheel and a second space separated from the first space in an essentially fluid-tight manner. When the fluid pressure in the second space is increased, the actuating area of the piston element brings the friction surface formations into frictional engagement with each other and thus connects the housing and the turbine wheel together for rotation in common around an axis of rotation.

2. Description of the Related Art

A hydrodynamic torque converter of this type is known from U.S. Pat. No. 5,964,329, in which each of the two friction surface formations is formed by several ring-like disk or ring-like plate friction elements. These can be pressed into frictional engagement with each other by the piston element. The radially inner area and the radially central area of the piston element are guided with freedom of axial movement along the housing in a fluid-tight manner. Therefore, the second space is also situated radially in the area between the radially inner seal and the radially central seal. In an area extending over the radially central seal and beyond in the radially outward direction, the piston element extends into the area of the friction surface formations and is able to press these against each other when the pressure in the second space is increased. So that heat can be dissipated more effectively from the area of these frictionally interacting friction surface formations, the piston element has a pass-through opening outside the area in which it forms part of the boundary of the second space to allow the fluid introduced into the first space to flow onto the side of the radially outer area of the piston element facing away from the friction surface formations and thus to allow the fluid introduced into the first space to flow more effectively around the frictionally interacting surface areas.

### SUMMARY OF THE INVENTION

An object of the present invention is to design a hydrodynamic torque converter in such a way that, in the area of the friction formations to be brought into frictional interaction with each other, a better cooling action can be provided by the fluid to be introduced into the interior of the housing.

According to the invention, a fluid flow arrangement which connects the second space to the first space is provided in the piston arrangement in the radial area of the friction surface formations.

In comparison with the previously indicated prior art, the hydrodynamic torque converter of the inventive design offers various advantages. First, the fluid flow opening arrangement establishes a connection between the second space and the first space. Especially when the bridging clutch arrangement is to be activated, that is, when the friction surface formations are to be brought into frictional engagement with each other, the fluid pressure in the second space is higher than that in the first space, which means that fluid will flow at comparatively high pressure and correspondingly high velocity through the fluid flow opening arrangement. This leads to a significant improvement in the forced flow of fluid around the surfaces areas to be cooled. Because the fluid flow opening arrangement is located in the radial area of the friction surface formations, that is, precisely where the heat is generated by friction and precisely in the area from which the heat must be carried away, optimal use can thus be made of the cooling action which can be achieved.

The hydrodynamic torque converter can be designed in such a way, for example, that a first fluid supply channel arrangement has a feed channel area leading to the first space and a discharge channel area leading away from the first space, and that a second fluid supply channel arrangement is provided to supply fluid to the second space and to carry it away from that space essentially independently of the first fluid supply channel arrangement. This means that the converter is of the so-called 3-line type; that is, the fluid feed to the first space can occur separately or independently of the fluid feed to the second space.

It is also possible, for example, for the first friction surface formation to comprise at least one ring-shaped disk element connected essentially nonrotatably to the housing and for the second friction surface formation to comprise at least one ring-shaped disk element connected essentially nonrotatably to a friction element carrier.

The fluid flow opening arrangement can comprise at least one through-opening formed in the piston element. The minimum of one through-opening in the piston element can extend through the piston element at a radially outward-directed slant from the second space to the first space. As a result of this slanted positioning, that is, at an angle to the axis of rotation and at an angle to a plane perpendicular to the axis of rotation, advantage can be taken of the centrifugal forces acting on the fluid flowing into the second space to promote the flow. As a result of this flow direction, which is already directed radially outward onto the friction surface formations, furthermore, the effect of a jet nozzle is obtained, which provides an even greater boost to the radially outward transport of fluid into the first space.

Alternatively, it is possible for at least one through-opening in the piston element to proceed essentially in the axial direction. This is especially advantageous in cases where the minimum of one friction element of the second friction surface formation is connected essentially nonrotatably to the carrier by a set of teeth and at least one through-opening leading to the first space is present in the radial area of this set of teeth. In this case, the fluid leaving the second space flows directly into the area in which at least one friction element is connected to the carrier. In the area of the teeth which form this connection, intermediate spaces are usually present, which allow the fluid to pass through in the axial direction and thus promote the distribution of fluid over the entire area of the frictionally interacting surfaces.

So that effective use can be made of the centrifugal force effects already mentioned, it is also proposed that least one through-opening be provided radially inside the actuating area of the piston element and that, in the actuating area, at least one through-channel be provided, which bridges the actuating area in the radial direction.

To ensure that the second space is closed off in an essentially fluid-tight manner from the first space while at the same time the piston element is free to shift and thus to engage and disengage the bridging clutch arrangement, it is proposed that the radially outer area of the piston element be guided with freedom of axial movement along a guide section of the housing under the action of a sealing arrangement, where the sealing arrangement comprises a sealing element on the piston element and a sealing surface on the housing, along which the sealing element can slide. With a design of this type, the fluid flow opening arrangement can comprise at least one fluid flow channel on the sealing element, where this channel can be designed, for example, as a groove-like recess in the outer circumferential area of the sealing element.

Alternatively, it is also possible for the fluid flow opening arrangement to comprise at least one fluid flow channel in the sealing surface. The minimum of one fluid flow channel can comprise a groove-like recess in the sealing surface.

So that use can also be made of the fluid introduced into the first space to obtain the most efficient possible cooling of the bridging clutch arrangement, it is proposed that a fluid guide element, adjacent to the piston element, be provided in the first space and that this guide element, together with the piston element, form the boundary of a subsection of the first space extending radially from the inside from the point where the fluid is fed into to the first space radially outward to the area of the friction surface formations.

According to another aspect of the invention, a first fluid supply channel arrangement has a feed channel area leading to the first space and a discharge channel area leading away from the first space, and a second fluid supply channel arrangement supplies fluid to the second space and carries it away from that space essentially independently of the first fluid supply channel arrangement; where a fluid flow opening arrangement connecting the second space to the first space is provided in the piston element.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a partial longitudinal cross section through a hydrodynamic torque converter;

FIG. 2 shows an enlarged, detailed view of the area of the bridging clutch arrangement of the hydrodynamic torque converter shown in FIG. 1;

FIG. 3 shows a view corresponding to FIG. 2 of a modified embodiment;

FIG. 4 shows a view corresponding to FIG. 2 of a modified embodiment; and

FIG. 5 shows a view corresponding to FIG. 2 of a modified embodiment.

### DETAILED DESCRIPTION OF THE PRESENTLY PREFERRED EMBODIMENTS

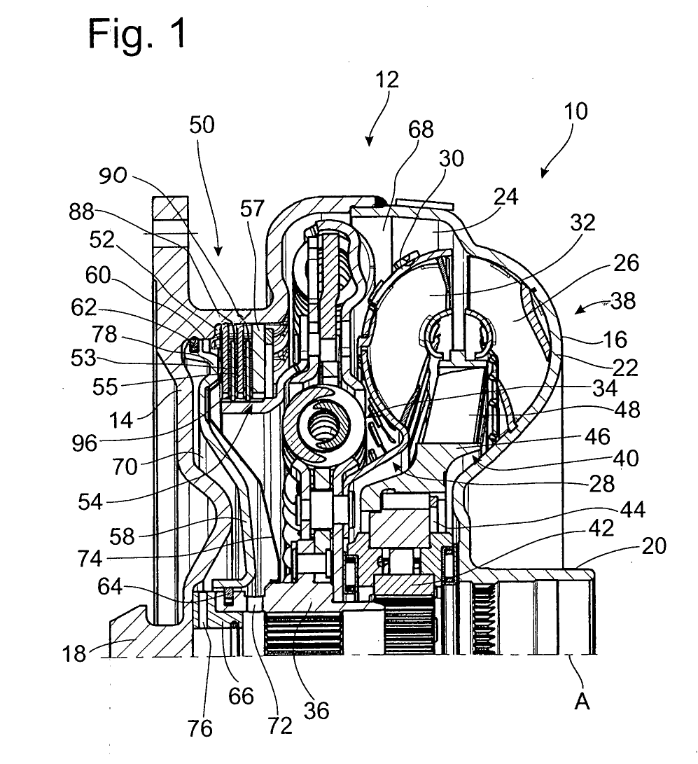

The hydrodynamic torque converter 10 shown in FIG. 1 comprises a housing 12 with two housing parts 14, 16. The housing part 14 carries a journal 18 in the radially inner area, which is intended and/or designed to be connected to a drive shaft. The housing part 16, permanently connected by welding to the housing part 14 in the radially outside area, forms a converter hub 20 in the radially inside area, this hub being designed to be engaged and positioned in a gearbox, whereas the area located further outward in the radial direction forms a pump wheel shell 22. On the side facing an interior space 24 of the housing 12, several pump wheel vanes 26 are mounted on the pump wheel shell 22, arranged in a row in the circumferential direction around the axis of rotation A. In the interior space 24, furthermore, a turbine wheel 28 is provided. This comprises a turbine wheel shell 30 with a plurality of turbine wheel vanes 32 mounted on it, opposite the pump wheel vanes 26. The turbine wheel shell 30 is connected to a turbine wheel hub 36 by way of a torsional vibration damper arrangement 34. The turbine wheel hub 36 is provided with a set of teeth on its inner circumferential side, so that, with these teeth, it can engage for rotation in common with a takeoff shaft, such as for example, a gearbox input shaft.

A stator 40 is provided axially between the turbine wheel 28 and the pump wheel 38, the latter being formed essentially by the pump wheel vanes 26 and the pump wheel shell 22. A stator hub 42 is mounted nonrotatably on a support shaft (not shown). By way of a freewheel 44, which blocks rotation in one direction, the stator hub carries a stator ring 46, on which a plurality of stator vanes 48 is mounted.

A bridging clutch arrangement 50 is used to bypass the hydrodynamic circuit and thus to transmit torque directly between the housing 12 and the turbine wheel 28 and therefore to the takeoff shaft. For this purpose, the bridging clutch arrangement 50 has friction surface formations 52 and 54, which can be brought into frictional engagement with each other. One of these formations is provided on the housing 12, the other on a carrier 56, which is connected to the turbine wheel 28 or to the turbine wheel hub 36 by way of a torsional vibration damper 34 of a two-stage design. Each of these friction surface formations comprises several ring-shaped disk-like friction elements or plates, where the friction elements 53, 55, 57 of the first friction surface formation 52 have sets of teeth, which engage with teeth on the housing part 14 in an essentially nonrotatable manner while still allowing freedom of axial movement relative to the housing, whereas the friction elements 88, 90 of the second friction surface formation 54 have sets of teeth by which they are connected in a corresponding manner with the carrier 56 in nonrotatable fashion with but freedom of axial movement relative to the carrier.

A piston element 58 of the bridging clutch arrangement 50 is guided with freedom of axial movement on the housing 12. For this purpose, the housing 12 or housing part 14 of the housing has, in the radially outer area, a guide surface 60, along which a sealing element 62, located in the radially outer area of the piston element 58, can slide in the axial direction. At its radially inner end, the piston element 58 is also guided in a fluid-tight and axially movable manner, namely, on an axial terminal area of the turbine wheel hub 36, via the sealing element 64 installed there between the two components. This terminal area of the hub is in turn supported radially and axially on a bearing part 66, which is connected by welding to the inner area of the housing part 14, for example, an essentially fluid-tight contact being created between the turbine wheel hub 36 and the bearing part 66.

The interior space 24 of the housing is divided by the piston element 58 into two spaces 68, 70. A first space 68, situated in FIG. 1 on the right of the piston element 58, contains essentially the turbine wheel 28, the torsional vibration damper 34, and the friction surface formations 52, 54 of the bridging clutch arrangement 50. By way of one or more openings 72 in the turbine wheel hub 36 and a feed channel arrangement leading to them, fluid, such as lubricating oil, can be introduced into the first space 68. This fluid is guided radially outward, namely, into the area of the friction surface formations 52, 54, by a ring-shaped disk-like guide element 74, which is supported on the turbine wheel hub 36 and extends into the area of the friction surface formations 52, 54. There, the fluid flows around the surfaces which are to be brought into frictional interaction with each other and arrives in that part of the space 68 in which the turbine wheel 28 is also situated. After passing by the axial support bearings for the stator provided in the radially inner area, the fluid can be taken away from the first space 68 via a discharge channel arrangement. It is obvious that the feed channel arrangement or the discharge channel arrangement can comprise through-openings in the gearbox input shaft, for example, and intermediate spaces between this gearbox input shaft and the support shaft or between the support shaft and the converter hub 20. In principle, therefore, the converter is of the 3-line type. The fluid circulation through the first space 68 can therefore be adjusted independently of the fluid feed to and/or the fluid discharge from the second space 70. For this purpose, one or more openings 76, through which, for example, fluid which has been supplied through a central opening in the gearbox input shaft can be fed into the second space 70, can also be provided in the previously mentioned bearing part 66, which is permanently connected to the housing part 14. If the bridging clutch arrangement 50 is to be engaged, the fluid pressure in the second space 70 is increased by supplying fluid appropriately to that space, and thus the actuating area 78 of the piston element 58 located in the radial area of the friction surface formations 52, 54 is pressed against the friction surface formations 52, 54, i.e., against the friction element 53 of the friction surface formation 52. As a result, the various friction elements—some of which, e.g., friction elements 88, 90 of the friction surface formation 54, for example, can carry friction linings—come into frictional contact with each other and transmit torque directly between the housing 12 and the turbine wheel 28 or the turbine wheel hub 36 via the carrier 56 and the torsional vibration damper 34.

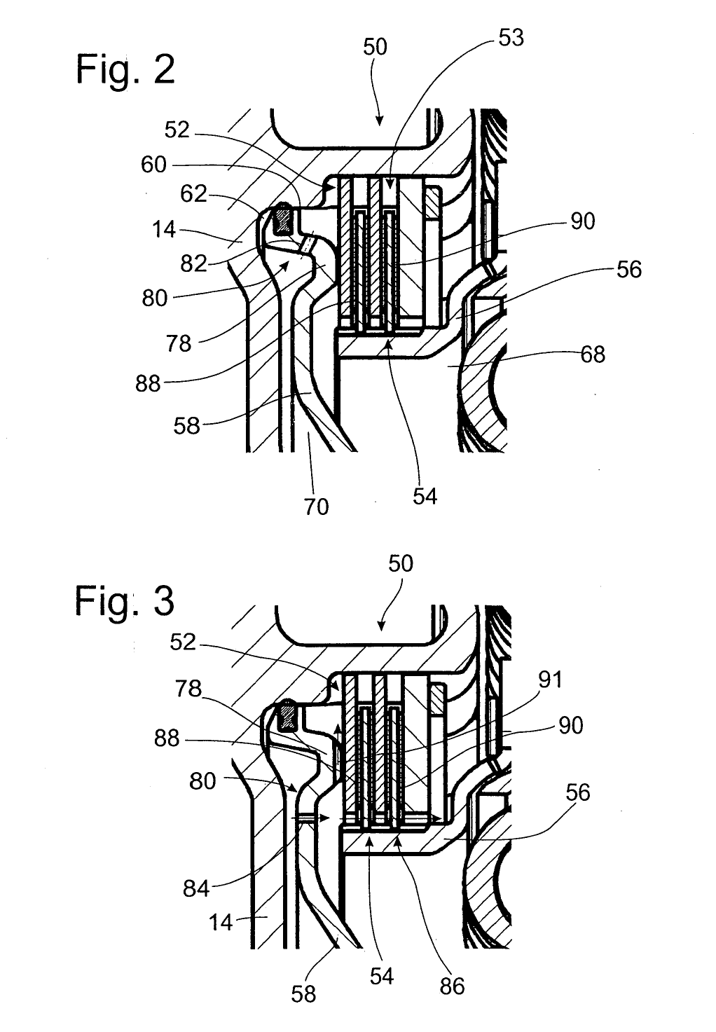

In FIG. 2, it can be seen that a fluid flow opening arrangement 80 is provided in the piston element 58. This flow opening arrangement establishes a flow connection between the second space 70 and the first space 68. In the example shown here, the fluid flow opening arrangement 80 comprises one or more through-openings 82 distributed around the circumference of the piston element 58. Here they are located radially outside the actuating area 78 but still in the area over which the friction surface formations 52, 54 extend. It can also be seen that the through-openings 82 extend radially outward at a slant, so that the fluid in the space 70, which is under greater pressure than that in space 68, emerges from the second space 70 radially outward at an angle and is therefore, as it enters the first space 68, aimed directly at the friction surface formations 52, 54. Especially therefore, when, as the result of an increase in the fluid pressure in the second space 70, the bridging clutch arrangement 50 is to be engaged, the surface areas of the friction surface formations 52, 54 which are entering into frictional engagement with each other are subjected to an even greater flow of fluid. Thus, especially through the combination of the orientation of the through-openings 82 shown in FIG. 2 with the flow guide element 74 shown in FIG. 1, it is possible to intensify the transport of fluid in the radially outward direction in a manner similar in principle to that of a jet nozzle or jet pump.

In a modification as shown in FIG. 3, the fluid flow opening arrangement 80 again comprises one or more through-openings 84, but now they are oriented essentially in the axial direction and are located radially in the area where the friction elements 88, 90 of the friction surface formation 54 mounted on the carrier 56 are connected by sets of teeth to the carrier 56. In the area of this toothed coupling 86 between the carrier 56 and the friction elements 88, 90 of the friction surface formation 54, intermediate spaces are formed, through which in any case the fluid has the opportunity to flow axially, which therefore ensures that the friction elements will be supplied with sufficient flow. The fluid emerging axially from the through-openings 84 under high pressure and therefore at high velocity arrives precisely in this area and thus supports the flow around the friction surface formations 52, 54. So that the flow in the radially outward direction can also be intensified, several radially outward-leading through-channels 91 are provided in the actuating area 78 of the piston element 58, distributed around the circumference, and these can be open axially in the direction toward the friction surface formations 52, 54. Through these channels, the fluid emerging from the through-openings 84 will be able to reach the radially outer area under the action of centrifugal force.

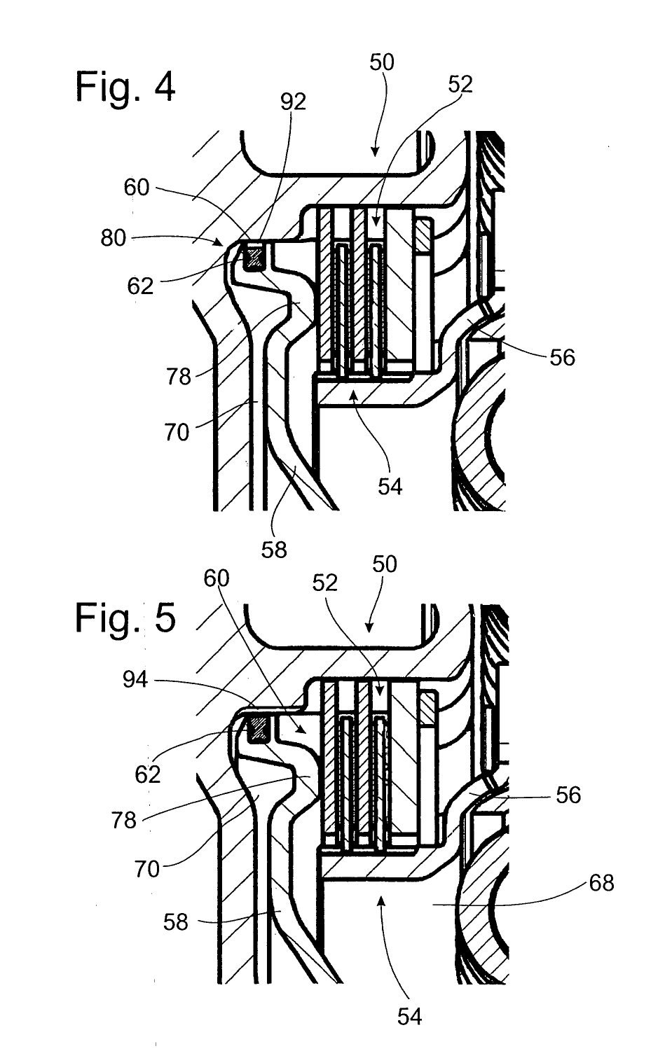

Another modification is shown in FIG. 4. Here again, it is possible to see the piston element 58 with its actuating area 78 and the radially outer seal 62. The fluid flow opening arrangement 80 comprises in this embodiment one or more groove-like recesses 92 in a circumferential row, distributed around the outside circumference of the sealing element 62, that is, in the area where this element enters into sealing interaction with the guide surface or sealing surface 60. Thus, fluid present under a higher fluid pressure in the second space 70 can flow axially through the sealing element 62 at these areas, from which it then proceeds to the radial area of the friction surface formations 52, 54 and carries heat away from them.

This principle can be realized in an alternative variant as shown in FIG. 5. Here, preferably several groove-like recesses 94, arranged in a circumferential row, are provided on the guide surface or sealing surface 60. These grooves bridge the sealing element 62 and therefore allow the fluid to enter from the second space 70 and proceed to the first space 68 in the radial area of the friction surface formations 52, 54.

It should be pointed out in conclusion that, of course, the various design variants of the fluid flow opening arrangement can be combined with each other. Thus, through appropriate choice of the dimensions of the various flow cross sections, it can be ensured that, even under consideration of the delivery capacity of a fluid pump in the second space, a sufficiently high fluid pressure can always be produced to keep the bridging clutch arrangement in the completely engaged state.

It should also be pointed out that, with respect to its additional assemblies, e.g., the turbine wheel and the torsional vibration damper, the hydrodynamic torque converter 10 can also be designed in ways different from those described above. The bridging clutch arrangement can also be designed differently, especially with respect to the friction surface formations. Thus, for example, one of the friction surface formations could be formed directly on a carrier, or a different number of frictionally interacting friction elements or friction elements of a different shape could be provided.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A hydrodynamic torque converter comprising:
a converter housing with an interior space and a pump wheel;
a turbine wheel installed in the interior space and rotatable about an axis with respect to the housing;
a bridging clutch comprising a first friction surface formation which is connected essentially nonrotatably to the converter housing, and a second friction surface formation which is connected essentially nonrotatably to the turbine wheel, the first and second friction formations lying in a radial area with respect to the axis; and
a piston element dividing the interior space into a first space containing the turbine wheel and a second space facing away from the first space, wherein a pressure increase in the second space brings the first and second friction formations into frictional engagement to connect the housing to the turbine wheel for rotation in common, the piston element having a fluid flow opening arrangement connecting the second space to the first space in the radial area of the friction surface formations.

2. The hydrodynamic torque converter of claim 1 further comprising:
a first fluid supply channel arrangement comprising a first feed channel leading to the first space and a first discharge channel leading away from the first space; and
a second fluid supply channel arrangement for supplying fluid to the second space and carrying fluid away from the second space independently of the first fluid supply channel arrangement.

3. The hydrodynamic torque converter of claim 1 further comprising a friction element carrier fixed to the turbine wheel hub, wherein
the first friction surface formation comprises at least one ring-shaped friction element connected essentially nonrotatably to the converter housing, and
the second friction surface formation comprises at least one ring-shaped friction element connected essentially nonrotatably to the friction element carrier.

4. The hydrodynamic torque converter of claim 1 wherein the fluid flow opening arrangement comprises at least one through-opening in the piston element.

5. The hydrodynamic torque converter of claim 4 where the at least one through opening extends from the second space at the first space at an acute angle to a radius from the axis.

6. The hydrodynamic torque converter of claim 4 where the at least one through opening extends from the second space at the first space parallel to the axis.

7. The hydrodynamic torque converter of claim 3 wherein
the at least one friction element of the second friction formation is connected to the friction element carrier by a set of teeth lying in a radial area with respect to the axis, and
the fluid flow opening arrangement comprises at least one through-opening in the piston element, wherein said at least one through-opening opens in the radial area of said set of teeth.

8. The hydrodynamic torque converter of claim 4 wherein the piston element contacts one of the friction surface formations at an actuating area, the at least one through-opening lying radially inside the actuating area, the piston element being formed with at least one radially extending channel which bridges the actuating area in the first space.

9. The hydrodynamic torque converter of claim 1 further comprising a sealing arrangement between the piston element and the converter housing, the sealing arrangement comprising a sealing element on the piston element and a sealing surface on the housing, wherein the sealing element can slide on the sealing surface.

10. The hydrodynamic torque converter of claim 9 wherein the fluid flow opening arrangement comprises at least one fluid flow channel in the sealing element.

11. The hydrodynamic torque converter of claim 10 wherein the at least one fluid flow channel comprises a radially outward facing groove in the sealing element.

12. The hydrodynamic torque converter of claim 9 wherein the fluid flow opening arrangement comprises at least one fluid flow channel in the sealing surface.

13. The hydrodynamic torque converter of claim 12 wherein the at least one fluid flow channel comprises a radially inward facing groove in the sealing surface.

14. The hydrodynamic torque converter of claim 1 further comprising a fluid guide element adjacent to the piston element in the first space, said guide element and said piston element bounding a subsection of the first space where fluid is fed radially outward toward the friction surface formations.

15. A hydrodynamic torque converter comprising:
a converter housing with an interior space and a pump wheel;
a turbine wheel installed in the interior space and rotatable about an axis with respect to the housing;
a bridging clutch comprising a first friction surface formation which is connected essentially nonrotatably to the converter housing, and a second friction surface formation which is connected essentially nonrotatably to the turbine wheel;
a piston element dividing the interior space into a first space containing the turbine wheel and a second space facing away from the first space, wherein a pressure increase in the second space brings the first and second friction formations into frictional engagement to connect the housing to the turbine wheel for rotation in common, the piston element having a fluid flow opening arrangement connecting the second space to the first space;
a first fluid supply channel arrangement comprising a first feed channel leading to the first space and a first discharge channel leading away from the first space; and
a second fluid supply channel arrangement for supplying fluid to the second space and carrying fluid away from the second space independently of the first fluid supply channel arrangement.
